(19) United States
(12) Patent Application Publication
(10) Pub. No.: US 2018/0197697 A1
(43) Pub. Date: Jul. 12, 2018

(54) SLIM-TYPE KEY STRUCTURE

(71) Applicant: PRIMAX ELECTRONICS LTD., Taipei (TW)

(72) Inventors: BO-AN CHEN, Taipei (TW); CHIN-SUNG PAN, Taipei (TW)

(21) Appl. No.: 15/493,926

(22) Filed: Apr. 21, 2017

(30) Foreign Application Priority Data
Jan. 6, 2017 (TW) 106100441

(51) Int. Cl. H01H 13/705; H01H 3/12; H01H 13/85

(52) U.S. Cl. CPC H01H 13/705; H01H 2215/004; H01H 13/85; H01H 3/125

(57) ABSTRACT

A slim-type key structure includes a keycap, a base plate, a scissors-type connecting element, a membrane circuit board, a metal dome and a positioning plate. The keycap can be pressed. The scissors-type connecting element is located under the keycap. The membrane circuit board is disposed on the base plate. The metal dome is disposed on the membrane circuit board. In response to a pressing force, the metal dome is subjected to a compressed deformation to press the membrane circuit board. When the pressing force is released, a restoring force is generated and the metal dome is restored to an original shape in response to the restoring force. The positioning plate includes a pressing post. The pressing post is aligned with a center of the metal dome and a center of the keycap. The positioning plate is fixed on the metal dome through an adhesive.

### FIELD OF THE INVENTION

The present invention relates to a slim-type key structure, and more particularly to a key structure using a metal-dome elastic element as a restoring mechanism in order to reduce the overall volume.

### BACKGROUND OF THE INVENTION

As known, computers such as desktop computer (e.g., personal computers) or notebook computers are essential tools in our daily lives. Moreover, keyboards are important input devices of computers. Via the keyboards, users can input characters or perform control operations. Generally, a keyboard comprises plural key structures. These key structures are located at specified positions. Moreover, many electronic devices or electrical operation devices are equipped with key structures that are used as operation interfaces of performing various designated functions.

For allowing users to perform the input and control operations, the key structures of the keyboard are specially designed. That is, the key structure is returned to its original position in response to a single pressing action, and a triggering signal is generated in response to the pressing action. Due to the compressible restoring mechanism of the key structure, the tactile feel of successfully pressing the key structure for the user is enhanced. In addition, the same key structure can be used to provide the next pressing action.

As for the conventional keyboards, the key structures are classified according to the types of the switches in the key structures. For example, the key structures are classified into some types, including mechanical key structures, membrane key structures, conductive rubber key structures and contactless electrostatic capacitive key structures. Generally, the use lives, the tactile feels and the fabricating cost for different types of key structures are usually different. Moreover, the key structure is usually equipped with a scissors-type connecting element under the keycap. Due to the scissors-type connecting element, the pressing force can be effectively and uniformly distributed. Consequently, the key structure can be successfully pressed to generate the accurate triggering result.

In addition to the scissors-type connecting element, the key structure further comprises a rubber-dome elastic element corresponding to the scissors-type connecting element. Due to the rubber-dome elastic element, the scissors-type connecting element can be returned to its original position. If the key structure is only equipped with the scissors-type connecting element but not equipped with the rubber-dome elastic element, the key structure cannot be normally operated. Moreover, if the key structure is only equipped with the rubber-dome elastic element as the compressible restoring mechanism but not equipped with the scissors-type connecting element, the distribution of the pressing force is usually not uniform. Under this circumstance, it is difficult to build the larger-area keycap of the key structure of the general keyboard. On the other hand, regardless of whether the keyboard of the notebook computer or the stand-alone keyboard of the desktop computer is used, the trend of designing the keyboard is toward slimness in appearance and volume.

However, even if the rubber-dome elastic element is not compressed, the rubber-dome elastic element has a bulky volume. In case that the key structure of the keyboard is equipped with the rubber-dome elastic element, the production of the keyboard is limited by the material of the component. Under this circumstance, it is difficult to reduce the overall volume of the key structure or fabricate the slim-type keyboard.

### SUMMARY OF THE INVENTION

The present invention provides a slim-type key structure. The slim-type key structure is applied to a keyboard. The slim-type key structure uses a metal-dome elastic element as a restoring mechanism. Consequently, the overall volume or thickness of the key structure or the keyboard is reduced to meet the slimness requirement.

In accordance with an aspect of the present invention, there is provided a slim-type key structure. The slim-type key structure is installed on a keyboard. The slim-type key structure includes a keycap, a base plate, a scissors-type connecting element, a membrane circuit board, a metal dome and a positioning plate. The keycap can be pressed. The scissors-type connecting element is located under the keycap and disposed on the base plate. The membrane circuit board is disposed on the base plate. The metal dome is disposed on the membrane circuit board. In response to a pressing force, the metal dome is subjected to a compressed deformation to press the membrane circuit board. When the pressing force is released, a restoring force is generated and the metal dome is restored to an original shape in response to the restoring force. The positioning plate is located under the keycap and disposed on the metal dome. The positioning plate includes a pressing post. The pressing post is aligned with a center of the metal dome and a center of the keycap. The positioning plate is fixed on the metal dome through an adhesive.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic exploded view illustrating a slim-type key structure according to an embodiment of the present invention;

FIG. 1B is a schematic assembled view illustrating the slim-type key structure according to the embodiment of the present invention; and

FIG. 2 is a schematic cross-sectional view illustrating the slim-type key structure according to the embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

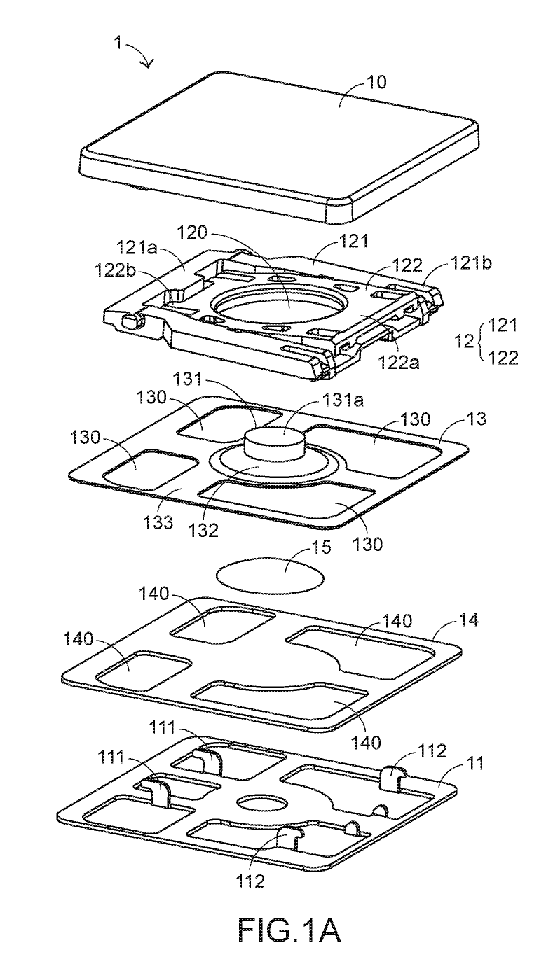

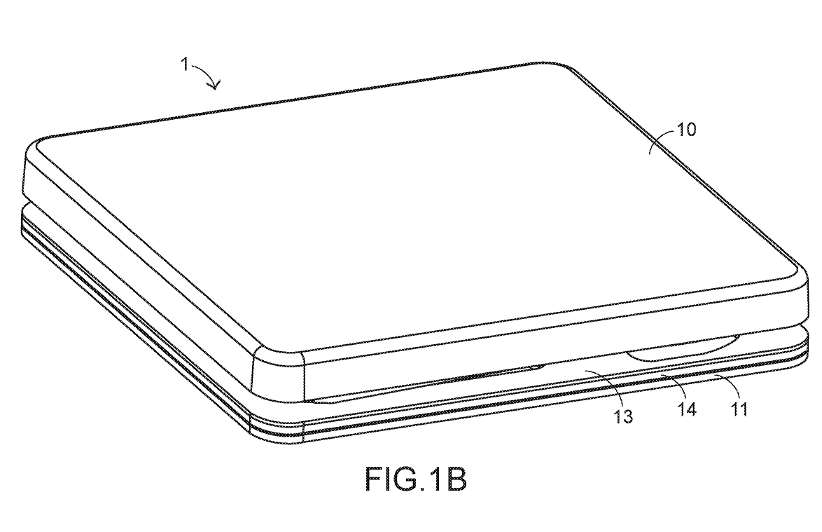

Hereinafter, an example of a slim-type key structure will be illustrated with reference to FIGS. 1A and 1B. FIG 1A is a schematic exploded view illustrating a slim-type key structure according to an embodiment of the present invention. FIG. 1B is a schematic assembled view illustrating the slim-type key structure according to the embodiment of the present invention. The slim-type key structure 1 is installed on a keyboard (not shown). The keyboard comprises plural slim-type key structures 1. Moreover, the keyboard is a built-in keyboard module of a notebook computer or a stand-alone keyboard of a desktop computer.

As shown in FIG. 1A, the slim-type key structure 1 comprises a keycap 10, a scissors-type connecting element 12, a positioning plate 13, a metal dome 15, a membrane circuit board 14 and a base plate 11. The relationships between the components of the slim-type key structure 1 from top to bottom can be seen in FIG. 1A. From the assembled view of FIG. 1B, it is found that there is a distance between the overlying keycap 10 and the underlying base plate 11. Due to this distance, an operating space for the user to press the keycap 10 is provided. It is noted that the sizes of the key structures of the keyboard may be identical or different. The size of the slim-type key structure 1 as shown in FIGS. 1A and 1B may be varied according to the practical requirements. However, the detailed feature and the assembling process of the slim-type key structure 1 are kept unchanged while retaining the teachings of the present invention.

In this embodiment, the keycap 10 can be pressed. The base plate 11 is a portion of the keyboard or the notebook computer where the slim-type key structure 1 is installed. For example, the keycap 10 is a portion of a housing of the keyboard. The scissors-type connecting element 12 has a well-known X-structure. Due to the scissors-type connecting element 12, the thickness of the key structure or the keyboard can be effectively reduced. Moreover, when a pressing force (not shown) is applied to the keycap 10, the pressing force can be uniformly distributed to provide a stable and fast tactile feel. The conventional scissors-type connecting element has various designs. The typical scissors-type connecting element is an X-shaped supporting stand composed of two flat frame units, which are pivotally coupled to each other. In this embodiment, the scissors-type connecting element 12 comprises an outer frame 121 and an inner frame 122. The outer frame 121 and the inner frame 122 are combined together and pivotally coupled to each other with respect to a central axis. Moreover, the scissors-type connecting element 12 is located under the keycap 10 and disposed on the base plate 11.

In an embodiment, the positioning plate 13 is made of an elastic material such as polyester or resin. The positioning plate 13 is located under the keycap 10 and disposed on the metal dome 15. The metal dome 15 is made of stainless steel, copper or any other appropriate metallic material. The metal dome 15 is disposed on the membrane circuit board 14 and covered by the positioning plate 13.

As shown in FIG. 1A, the positioning plate 13 comprises a pressing post 131, a thin film part 133 and a convex structure 132. The pressing post 131 is aligned with the center of the metal dome 15 and the center of the keycap 10. Moreover, the pressing post 131 has a sufficient supporting area with respect to the area of the keycap 10. Due to the supporting area, the pressing force exerted on the keycap 10 can be supported and transmitted by the pressing post 131. Consequently, the keycap 10 can be moved in a vertical direction without inclination.

The thin film part 133 is disposed on the membrane circuit board 14. An outer periphery of the convex structure 132 is connected with the thin film part 133. A middle region of a surface of the convex structure 132 is connected with the pressing post 131. In an embodiment, the convex structure 132 and the pressing post 131 are integrally formed with the thin film part 133. That is, the pressing post 131, the thin film part 133 and the convex structure 132 are made of the elastic material such as polyester or resin. The convex structure 132 is a shell structure with a curvy surface. In response to the pressing force, the convex structure 132 is linked with the pressing post 131 and thus the convex structure 132 is subjected to a compressed deformation. In this embodiment, only the pressing post 131 is irradiated with an ultraviolet ray (UV). That is, the pressing post 131 is UV-cured. Consequently, the pressing post 131 is a more rigid structure to provide effective transmission or link efficacy.

In accordance with a feature of the present invention, the key structure 1 of the keyboard uses the metal-dome elastic element (i.e., the metal dome 15) as a restoring mechanism of the key structure 1. Since the metal dome 15 is made of stainless steel or copper, the volume or thickness of the metal dome 15 is smaller than that of the conventional rubber-dome elastic element. Moreover, the tactile feel of pressing the key structure with the metal-dome elastic element and the tactile feel of pressing the key structure with the rubber-dome elastic element are distinguished. In particular, the tactile feel of pressing the key structure with the metal-dome elastic element is similar to the tactile feel of pressing a mechanical key structure.

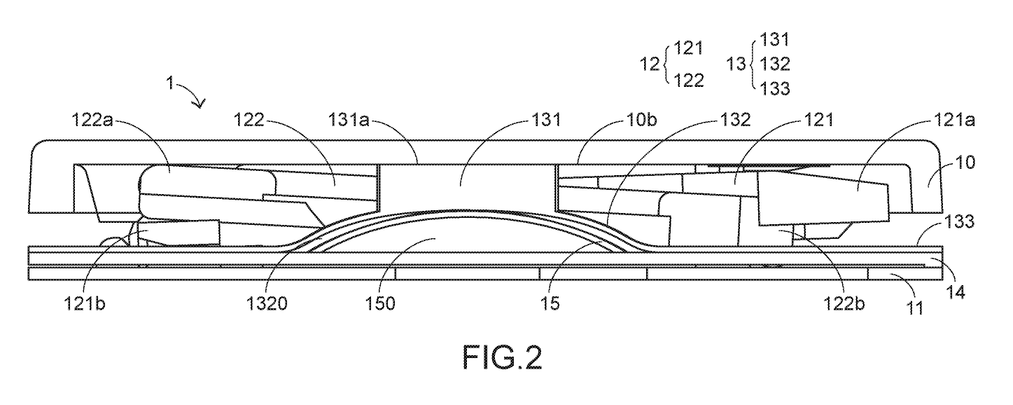

FIG. 2 is a schematic cross-sectional view illustrating the slim-type key structure according to the embodiment of the present invention. In this embodiment, the metal dome 15 is a nearly semi-spherical shell structure or a so-called “snap dome”. When the metal dome 15 is subjected to a deformation, the metal dome 15 is contacted with the underlying membrane circuit board 14. As shown in FIG. 2, a first chamber 150 facing the membrane circuit board 14 is formed within the metal dome 15. Moreover, a second chamber 1320 is formed within the convex structure 132 of the positioning plate 13. The second chamber 1320 is located at a side of the convex structure 132 that is opposite to the pressing post 131. The metal dome 15 is accommodated within the second chamber 1320. The first chamber 150 provides a deformation space in response to the pressing force.

In an embodiment, the metal dome 15 is aligned with the pressing post 131 and fixed in the second chamber 1320 through an adhesive (not shown). For example, the adhesive is arranged between the metal dome 15 and the inner side of the convex structure 132. Moreover, the periphery of the metal dome 15 is fixed on a designated position of the membrane circuit board 14 through the adhesive. At the same time, the thin film part 133 is also fixed on the membrane circuit board 14 through the adhesive. Consequently, when the metal dome 15 is pressed, the metal dome 15 can be effectively positioned and fixed and not shifted.

Moreover, the scissors-type connecting element 12 comprises an opening 120. In this embodiment, the opening 120 is formed in the inner frame 122. The size of the opening 120 is larger than the size of the pressing post 131. The pressing post 131 is penetrated through the opening 120 and aligned with a bottom surface 10b of the keycap 10. That is, a top surface 131a of the pressing post 131 is contacted with the bottom surface 10b of the keycap 10. After the above components are assembled, the resulting structure of the key structure 1 is shown in FIG. 2. As shown in FIG. 2, the keycap 10 is not pressed down.

In this embodiment, a first end 121a of the outer frame 121 and a first end 122a of the inner frame 122 are pivotally coupled to the bottom surface 10b of the keycap 10. A second end 121b of the outer frame 121 and a second end 122b of the inner frame 122, which are opposed to the first ends 121a and 122a, are movably coupled to the base plate 11. As shown in FIG. 1A, the base plate 11 is equipped with two hooks 111 corresponding to the second end 122b of the inner frame 122. Consequently, the second end 122b of the inner frame 122 is movably coupled to the two hooks 111. Similarly, the base plate 11 is equipped with two hooks 112 corresponding to the second end 121b of the outer frame 121. Consequently, the second end 121b of the outer frame 121 is movably coupled to the two hooks 112. Moreover, plural coupling structures (not shown) are formed on the bottom surface 10b of the keycap 10. The first end 121a of the outer frame 121 and a first end 122a of the inner frame 122 are pivotally coupled to the coupling structures. In other words, the first end 121a and the second end 121b of the outer frame 121 and the first end 122a and the second end 122b of the inner frame 122 are pivotal shafts that are pivotally coupled or engaged with the corresponding structures.

Generally, the pivotally-coupled regions of the scissors-type connecting element 12 are not slid. On the other hand, while the keycap 10 is moved downwardly toward the base plate 11 in response to the pressing force, the outer frame 121 and the inner frame 122 are rotated relative to each other. Consequently, the movably-coupled regions of the scissors-type connecting element 12 are slid externally from the hooks 111 and 112. Under this circumstance, the keycap 10 can be smoothly moved downwardly, and thus the height of the keycap 10 is changed.

Please refer to FIG 1A again. For allowing the scissors-type connecting element 12 to be assembled or coupled with the base plate 11, the thin film part 133 of the positioning plate 13 and the membrane circuit board 14 further comprise plural perforations 130 and 140. The hooks 111 and 112 of the base plate 11 are penetrated through the corresponding perforations 130 and 140. Consequently, the second ends 121b and 122b of the scissors-type connecting element 12 can be coupled and contacted with the corresponding hooks 111 and 112.

It is noted that the design of the scissors-type connecting element is not restricted. For example, in another embodiment, the movably-coupled regions of the scissors-type connecting element are located at the bottom surface of the keycap and the base plate. As long as the position of the supported keycap is changed in the vertical direction and the keycap is not detached from the keycap, the design of the scissors-type connecting element is feasible. The ways of allowing the keycap to be changed in the vertical direction with detachment are well known to those skilled in the art, and are not redundantly described herein.

In this embodiment, the membrane circuit board 14 comprises an upper wiring layer and a lower wiring layer (not shown). The upper wiring layer and the lower wiring layer are separated from each other. When the metal dome 15 is subjected to the compressed deformation, the upper wiring layer and the lower wiring layer are contacted with each other and conducted. Consequently, a triggering signal is generated in response to the pressing operation of the user.

Due to the structural properties of the metal dome 15, a restoring force is generated and the metal dome 15 is restored to an original shape in response to the restoring force when the overlying pressing force is released. Since the deformation of the metal dome 15 is eliminated, the keycap 10 is pushed to its original position and the scissors-type connecting element 12 is restored to its original height. Moreover, since the convex structure 132 is no longer subjected to the deformation and the convex structure 132 is restored to its original shape, the upper wiring layer and the lower wiring layer are separated from each other again. Meanwhile, the triggering signal is not generated or the triggering signal is stopped.

The sequence of transmitting the pressing force will be described as follows. Firstly, the pressing force is transmitted from the keycap 10 to the positioning plate 13, especially the pressing post 131 of the positioning plate 13. Then, the pressing force is transmitted from the positioning plate 13 to the metal dome 15. That is, the pressing post 131 is linked to compress the underlying convex structure 132 and the metal dome 15. Consequently, the metal dome 15 is subjected to the deformation. Afterwards, the membrane circuit board 14 is pushed by the metal dome 15. In accordance with another feature of the present invention, the top surface 131a of the pressing post 131 has a sufficient supporting area. Consequently, the pressing force can be effectively transmitted from the keycap 10 to the downward region. Since the metal dome 15 is compressed in response to the downward force that is perpendicular to the base plate 11, the keycap 10 can be moved in a vertical direction without inclination. Since the membrane circuit board 14 can be accurately conducted and triggered, the operating sensitivity of the key structure is enhanced.

Moreover, since the thin film part 133 is fixed on the membrane circuit board 14 through the adhesive, the positioning plate 13 can be adhered to the membrane circuit board 14. The metal dome 15 is accommodated within the second chamber 1320 of the convex structure 132 and fixed in the second chamber 1320 through the adhesive. Due to these structures, the metal dome 15 can be effectively positioned and fixed on a specified position of the membrane circuit board 14 and not shifted. Due to the metal-dome elastic element, the volume or thickness of the key structure of the keyboard can be effectively reduced. Moreover, due to the scissors-type connecting element 12, the larger-area keycap of the key structure can be effectively and accurately pressed down. Consequently, the technology of fabricating the key structure of the keycap makes progress according to the present invention.

It is noted that numerous modifications and alterations may be made while retaining the teachings of the invention. For example, in another embodiment, the slim-type key structure further comprises an elastic coating layer (not shown). The elastic coating layer is able to reduce the noise from impact. For example, as shown in FIG. 2, the elastic coating layer is formed on the top surface 131a of the pressing post 131. That is, the elastic coating layer is located at the junction between the pressing post 131 and the bottom surface 10b of the keycap 10. The elastic coating layer is also made of an elastic material such as polyester or resin. Alternatively, the elastic coating layer is a film that is made of an elastic and anti-abrasion material. Consequently, the elastic coating layer is used as a contact buffering structure between the pressing post 131 and the bottom surface 10b of the keycap 10.

From the above descriptions, the present invention provides the slim-type key structure. The use of the metal-dome elastic element is helpful to reduce the volume of the key structure or achieve the slimness requirement of the keyboard. Although the metal dome has been applied to the key structures of other fields, the metal dome is only suitably used in the small-sized key structure (e.g., the operation button of the electronic appliance) according to the conventional technologies. According to the technology of the present invention, the metal dome can be successfully applied to the key structure of the keyboard. In accordance with the feature of the present invention, the use of the scissors-type connecting element and the special design of the positioning plate facilitate the slimness of the keyboard.

The slim-type key structure of the present invention can effectively solve the drawbacks of the conventional technology while achieving the purposes of the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A slim-type key structure installed on a keyboard, the slim-type key structure comprising:
a keycap to be pressed;
a base plate;
a scissors-type connecting element located under the keycap and disposed on the base plate;
a membrane circuit board disposed on the base plate;
a metal dome disposed on the membrane circuit board, wherein in response to a pressing force, the metal dome is subjected to a compressed deformation to press the membrane circuit board, wherein when the pressing force is released, a restoring force is generated and the metal dome is restored to an original shape in response to the restoring force; and
a positioning plate located under the keycap and disposed on the metal dome, wherein the positioning plate comprises a pressing post, and the pressing post is aligned with a center of the metal dome and a center of the keycap, wherein the positioning plate is fixed on the metal dome through an adhesive.

2. The slim-type key structure according to claim 1, wherein the membrane circuit board comprises an upper wiring layer and a lower wiring layer, and the upper wiring layer and the lower wiring layer are separated from each other, wherein when the metal dome is subjected to the compressed deformation to press the membrane circuit board, the upper wiring layer and the lower wiring layer are contacted with each other and conducted, so that a triggering signal is generated.

3. The slim-type key structure according to claim 1, wherein the metal dome is made of a metallic material, and the metallic material is stainless steel or copper, wherein the metal dome is a shell structure with a curvy surface, a first chamber facing the membrane circuit board is formed within the metal dome, and the first chamber provides a deformation space in response to the pressing force.

4. The slim-type key structure according to claim 1, wherein the positioning plate is made of an elastic material, and the elastic material is polyester or resin.

5. The slim-type key structure according to claim 1, wherein the positioning plate further comprises:
a thin film part disposed on the membrane circuit board; and
a convex structure, wherein an outer periphery of the convex structure is connected with the thin film part, the convex structure is a shell structure with a curvy surface, a second chamber is formed within the convex structure, and a middle region of a surface of the convex structure is connected with the pressing post, wherein the metal dome is accommodated within the second chamber, so that the positioning plate is fixed on the metal dome through the adhesive,
wherein in response to the pressing force, the convex structure is linked with the pressing post, and the convex structure and the metal dome are correspondingly subjected to the compressed deformation, wherein when the pressing force is released, the metal dome is restored to an original shape and the compressed deformation is eliminated.

6. The slim-type key structure according to claim 5, wherein the convex structure and the pressing post are integrally formed with each other, and the pressing post is further irradiated with an ultraviolet ray.

7. The slim-type key structure according to claim 5, wherein the thin film part is adhered and fixed on the membrane circuit board.

8. The slim-type key structure according to claim 1, wherein the scissors-type connecting element comprises an opening, and the pressing post is penetrated through the opening and contacted with a bottom surface of the keycap.

9. The slim-type key structure according to claim 8, further comprising an elastic coating layer, wherein the elastic coating layer is formed on a top surface of the pressing post and used as a contact buffering structure between the pressing post and the bottom surface of the keycap.

10. The slim-type key structure according to claim 8, wherein the scissors-type connecting element comprises an outer frame and an inner frame, and the outer frame and the inner frame are pivotally coupled to each other, wherein a first end of the outer frame and a first end of the inner frame are pivotally coupled to the bottom surface of the keycap, and a second end of the outer frame and a second end of the inner frame are movably coupled to the base plate.
